(19) United States
(12) Patent Application Publication
(10) Pub. No.: US 2023/0303761 A1
(43) Pub. Date: Sep. 28, 2023

(54) CURABLE RESIN COMPOSITION, CURED PRODUCT, LENS, AND LENS WITH A SUBSTRATE

(71) Applicant: AGC Inc., Tokyo (JP)

(72) Inventor: Jun YOSHIDA, Koriyama-shi (JP)

(73) Assignee: AGC Inc., Tokyo (JP)

(21) Appl. No.: 18/327,167

(22) Filed: Jun. 1, 2023

Related U.S. Application Data
(63) Continuation of application No. PCT/JP2021/044867, filed on Dec. 7, 2021.

(30) Foreign Application Priority Data
Dec. 14, 2020 (JP) 2020-206825

(51) Int. Cl. C08G 59/38; C08G 59/24; G02B 1/04

(52) U.S. Cl. CPC C08G 59/38; C08G 59/24; G02B 1/041

(57) ABSTRACT

One aspect of the present invention provides: a curable resin composition from which a cured product with excellent reliability at low temperatures can be obtained; a cured product and a lens with excellent reliability at low temperatures; and a substrate-attached lens comprising the lens.

The curable resin composition according to one aspect of the present invention comprises a diglycidyl ether compound having a bisphenol skeleton, a bifunctional alicyclic epoxy compound (excluding the diglycidyl ether compound), and a trifunctional or higher polyfunctional epoxy compound having an isocyanurate ring structure. The content of the diglycidyl ether compound is 30% by mass or more and the content of the polyfunctional epoxy compound is 20% by mass or less with respect to the total mass of resin components in the curable resin composition.

The cured product is one obtained by curing the curable resin composition of the present invention.

The lens comprises a cured product of the curable resin composition of the present invention.

The substrate-attached lens comprises a substrate and the lens provided on the substrate.

### TECHNICAL FIELD

The present invention relates to a curable resin composition, a cured product, a lens, and a lens with a substrate (a substrate-attached lens).

### BACKGROUND ART

Cured products of curable resin compositions comprising epoxy compounds are used in a wide range of fields such as optical lenses (for example, Patent Documents 1 and 2).

Patent Document 1 describes a cured product of a curable composition comprising an epoxy compound (A), which is a cured product having a flexural modulus of 2.5 GPa or more.

Patent Document 2 describes an ultraviolet-curable resin composition for producing an optical lens having an Abbe number of 50 or more.

### CITATION LIST

### Patent Documents

[Patent Document 1] International Patent Publication No. 2016/021577

[Patent Document 2] Japanese Unexamined Patent Application, First Publication No. 2010-150489

### SUMMARY OF INVENTION

### Technical Problem

Products composed of cured products of cured resin compositions, such as lenses, may be used in various environments, including cold regions. Therefore, it is important to have excellent reliability that can suppress defects such as cracks and distortion even at low temperatures.

However, the cured products of conventional ultraviolet-curable resin compositions such as those disclosed in Patent Documents 1 and 2 have insufficient reliability at low temperatures.

One aspect of the present invention provides a curable resin composition from which a cured product with excellent reliability at low temperatures can be obtained; a cured product and lens with excellent reliability at low temperatures; and a substrate-attached attached lens provided with the above lens.

### Solution to Problem

The present invention includes the following aspects.
[1] A curable resin composition comprising: a diglycidyl ether compound having a bisphenol skeleton; a bifunctional alicyclic epoxy compound (excluding the diglycidyl ether compound); and a trifunctional or higher polyfunctional epoxy compound having an isocyanurate ring structure, wherein a content of the diglycidyl ether compound is 30% by mass or more with respect to a total mass of resin components in the curable resin composition; and a content of the polyfunctional epoxy compound is 20% by mass or less with respect to the total mass of the resin components in the curable resin composition.
[2] The curable resin composition according to [1], wherein the content of the diglycidyl ether compound is from 30 to 50% by mass with respect to the total mass of the resin components in the curable resin composition.
[3] The curable resin composition according to [1] or [2], wherein a content of the bifunctional alicyclic epoxy compound is from 20 to 50% by mass with respect to the total mass of the resin components in the curable resin composition.
[4] The curable resin composition according to any one of [1] to [3], wherein the content of the polyfunctional epoxy compound is from 10 to 20% by mass with respect to the total mass of the resin components in the curable resin composition.
[5] The curable resin composition according to any one of [1] to [4], wherein a total content of the diglycidyl ether compound and the bifunctional alicyclic epoxy compound is from 60 to 85% by mass with respect to the total mass of the resin components in the curable resin composition.
[6] The curable resin composition according to any one of [1] to [5], wherein the diglycidyl ether compound is either one or both of a bisphenol A type epoxy resin and a bisphenol F type epoxy resin.
[7] The curable resin composition according to any one of [1] to [6], wherein the diglycidyl ether compound comprises a hydrogenated bisphenol skeleton.
[8] The curable resin composition according to any one of [1] to [7], further comprising an oxetane compound.
[9] The curable resin composition according to any one of [1] to [8], which is an ultraviolet-curable resin composition.
[10] The curable resin composition according to [9], further comprising an ultraviolet cationic polymerization initiator.
[11] The curable resin composition according to any one of [1] to [10], wherein a cured product of the curable resin composition has a breaking stress at −10° C. of 50 N/mm² or more.
[12] The curable resin composition according to any one of [1] to [11], wherein a cured product of the curable resin composition has a tensile modulus at −10° C. of 1,500 MPa or more.
[13] The curable resin composition according to any one of [1] to [12], wherein a cured product of the curable resin composition has a breaking elongation at −10° C. of 4% or more.
[14] The curable resin composition according to any one of [1] to [13], wherein a cured product of the curable resin composition has an Abbe number of 50 or more.
[15] A cured product of the curable resin composition according to any one of [1] to [14].
[16] A lens comprising the cured product according to [15].
[17] The lens according to [16], which has a temperature coefficient of refractive index of −150×10⁻⁶/K or more.
[18] A substrate-attached lens, comprising: a substrate; and the lens according to [16] or [17] provided on the substrate.

### Effects of Invention

According to the curable resin composition according to one aspect of the present invention, a cured product with excellent reliability at low temperatures can be obtained.

The cured product and lens according to one aspect of the present invention have excellent reliability at low temperatures.

A substrate-attached lens according to one aspect of the present invention comprises a lens with excellent reliability at low temperatures.

### BRIEF DESCRIPTION OF DRAWINGS

FIG. 1 is a plan view schematically showing a method of producing a test sample used in a tensile test in Examples.

FIG. 2 is a cross-sectional view schematically showing a method of producing a test sample used in a tensile test in Examples.

FIG. 3 is a plan view schematically showing a method of producing a test sample used for measuring the Abbe number and the temperature coefficient of refractive index in Examples.

FIG. 4 is a cross-sectional view schematically showing a method of producing a test sample used for measuring the Abbe number and the temperature coefficient of refractive index in Examples.

### DESCRIPTION OF EMBODIMENTS

The meanings and definitions of the terms used in the present specification are as follows.

A breaking stress at −10° C. of a cured product is measured by the method described in Examples.

A tensile modulus at −10° C. of a cured product is measured by the method described in Examples.

A breaking elongation at −10° C. of a cured product is measured by the method described in the Examples.

An “Abbe number” is a value calculated by the following formula 1 from the refractive index measured at 25±10° C. by an Abbe refractometer in accordance with JIS Z 8120. The “Abbe number” is an indicator of the reciprocal dispersive power of a so-called optical lens.

v_{D}=(n_{D}−1)/(n_{F}−n_{C}) Formula 1

In the Formula 1, v_{D} is the Abbe number. n_{D} is the refractive index for light with a wavelength of 589 nm. n_{F} is the refractive index for light with a wavelength of 486 nm. n_{C} is the refractive index for light with a wavelength of 656 nm.

A “temperature coefficient of refractive index” is measured by the method described in Examples.

A numerical range represented by a symbol “-” means a numerical range that includes numerical values before and after this symbol “-” as the lower limit and upper limit values.

The numerical ranges of the contents, various physical property values, and property values disclosed in the present specification can be made into new numerical ranges by arbitrarily combining the lower limit and upper limit values thereof.

### [Curable Resin Composition]

A curable resin composition according to one aspect of the present invention comprises a diglycidyl ether compound having a bisphenol skeleton (hereinafter also referred to as a “diglycidyl ether compound A”), a bifunctional alicyclic epoxy compound (excluding the diglycidyl ether compound A, hereinafter also referred to as a “bifunctional alicyclic epoxy compound B”), and a trifunctional or higher polyfunctional epoxy compound having an isocyanurate ring structure (hereinafter also referred to as a “polyfunctional epoxy compound C”).

The curable resin composition according to one aspect of the present invention is preferably a photocurable resin composition, and more preferably an ultraviolet-curable resin composition. The curable resin composition according to one aspect of the present invention may be a thermosetting resin composition.

Examples of the diglycidyl ether compound A include bisphenol A type epoxy resins and bisphenol F type epoxy resins. The number of types of diglycidyl ether compound A comprised in the curable resin composition may be one, or two or more.

The diglycidyl ether compound A preferably has a hydrogenated bisphenol skeleton from the viewpoint that cracks are less likely to occur in the cured product provided on a substrate. In other words, a diglycidyl ether compound having a hydrogenated bisphenol skeleton is preferred.

Examples of the diglycidyl ether compound having a hydrogenated bisphenol skeleton include hydrogenated bisphenol A type epoxy resins and hydrogenated bisphenol F type epoxy resins. The number of types of diglycidyl ether compound having a hydrogenated bisphenol skeleton comprised in the curable resin composition may be one, or two or more.

From the viewpoints that durability of the cured product is excellent at low temperatures, and cracks are less likely to occur in the cured product provided on a substrate, the diglycidyl ether compound A is preferably either one or both of a bisphenol A type epoxy resin and a bisphenol F type epoxy resin, and more preferably either one or both of a hydrogenated bisphenol A type epoxy resin and a hydrogenated bisphenol F type epoxy resin.

Examples of the bifunctional alicyclic epoxy compound B include a compound having two oxirane rings in which oxygen atoms are directly bonded to a cyclohexane ring or a condensed alicyclic skeleton; and a compound comprising no oxirane ring within an alicyclic molecular skeleton but having two glycidyl groups via a linking group. Specific examples thereof include 3,4-epoxycyclohexylmethyl-3,4-epoxycyclohexane carboxylate, 3,4-epoxycyclohexylethyl-3,4-epoxycyclohexane carboxylate, and diepoxidized compounds of tetrahydroindene. Moreover, the number of types of bifunctional alicyclic epoxy compounds B comprised in the curable resin composition may be one, or two or more.

A commercially available product may be used as the bifunctional alicyclic epoxy compound B. Examples thereof include “Celloxide 2021P” (product name of 3,4-epoxycyclohexylmethyl-3,4-epoxycyclohexane carboxylate manufactured by Daicel Corporation), “THI-DE” (product name of diepoxidized tetrahydroindene compound manufactured by JXTG Nippon Oil & Energy Corporation), and “HiREM-1” (product name, manufactured by Shikoku Chemicals Corporation).

Examples of the polyfunctional epoxy compound C include 1,3,5-triglycidyl isocyanurate, tris(2,3-epoxypropyl) isocyanurate, tris(α-methylglycidyl) isocyanurate, tris(1-methyl-2,3-epoxypropyl) isocyanurate, 1,3,5-tris(5,6-epoxybutyl)-1,3,5-triazine-2,4,6(1H,3H,5H)-trione, and tris{2,2-bis[(oxiran-2-ylmethoxy)methyl]butyl}-3,3′,3″-[1,3,5-triazine-2,4,6(1H,3H,5H)-trione-1,3,5-triyl] tripropanoate. The number of types of the polyfunctional epoxy compound C comprised in the curable resin composition may be one, or two or more.

A commercially available product may be used as the polyfunctional epoxy compound C. Examples thereof include “TEPTC-FL” (product name of 1,3,5-tris(5,6-epoxybutyl)-1,3,5-triazine-2,4,6(1H,3H,5H)-trione) and “TEPIC-UC” (product name of tris{2,2-bis[(oxiran-2-ylmethoxy)methyl]butyl}-3,3′,3″-[1,3,5-triazine-2,4,6(1H,3H,5H)-trione -1,3,5-triyl]tripropanoate) manufactured by Nissan Chemical Industries, Ltd.

The curable resin composition according to one aspect of the present invention may further comprise an oxetane compound. The oxetane compound may be a monofunctional oxetane compound or a polyfunctional oxetane compound. A monofunctional oxetane compound is an oxetane compound that has one oxetanyl group in one molecule and does not comprise a carbon-carbon double bond. A polyfunctional oxetane compound is an oxetane compound that has two or more oxetanyl groups in one molecule and does not comprise a carbon-carbon double bond.

Examples of the monofunctional oxetane compound include 3-ethyl-3-(2-ethylhexyloxymethyl) oxetane (such as “Aron Oxetane OXT-212” (product name) manufactured by Toagosei Co., Ltd.) and 3-ethyl-3-hydroxymethyl oxetane (such as “Aron Oxetane OXT-101” (product name) manufactured by Toagosei Co., Ltd.).

Examples of the polyfunctional oxetane compound include bis(3-ethyl-3-oxetanylmethyl)ether, 1,6-bis[(3-ethyloxetan-3-yl)methoxy]-2,2,3,3,4,5,5-octafluorohexane, 3 (4),8(9)-bi s[(1-ethyl -3-oxetanyl)methoxymethyl]-tricyclo[5.2.1.02.6]decane, 1,2-bis[2-[(1-ethyl-3-oxetanyl)methoxy]ethylthio]ethane, 2,3-bis[(3-ethyloxetan-3-yl)methoxymethyl]norbornane, 2-ethyl-2-[(3-ethyloxetan-3-yl)methoxymethyl]-1,3-o-bis[(1-ethyl-3-oxetanyl)methyl]-propane-1,3-diol, 2,2-dimethyl-1,3-o-bis[(3-ethyloxetan-3-yl)methyl]-propane-1,3-diol, 2-butyl-2-ethyl-1,3-o-bis[(3-ethyloxetan-3-yl)methyl]-propane-1,3-diol, 1,4-o-bis[(3-ethyloxetan-3-yl)methyl]-butane-1,4-diol, and 2,4,6-o-tris[(3-ethyloxetan-3-yl)methyl]cyanurate. One type of these oxetane compounds may be used, or two or more types thereof may be used.

The curable resin composition according to one aspect of the present invention may further comprise, as a resin component, a resin other than the diglycidyl ether compound A, the bifunctional alicyclic epoxy compound B, the polyfunctional epoxy compound C and the oxetane compound. Examples of other resins include monofunctional epoxy resins, bifunctional epoxy resins (excluding the diglycidyl ether compound A and the bifunctional alicyclic epoxy compound B), and epoxy-modified silicone resins.

The curable resin composition according to one aspect of the present invention preferably further comprises an ultraviolet cationic polymerization initiator in the case of an ultraviolet-curable resin composition, and more preferably further comprises an oxetane compound and an ultraviolet cationic polymerization initiator.

An ultraviolet cationic polymerization initiator generates an acid that can be cationically polymerized by UV irradiation. Examples thereof include diazonium salt-based compounds, iodonium salt-based compounds, sulfonium salt-based compounds, phosphonium salt-based compounds, selenium salt-based compounds, oxonium salt-based based compounds, ammonium salt-based compounds, and bromine salt-based compounds.

Examples of the anionic component of the ultraviolet cationic polymerization initiator include SbF₆⁻, PF₆⁻, BF₄⁻, AsF₆⁻, and B(C₆F₅)₄⁻.

As the ultraviolet cationic polymerization initiator, onium salts such as aromatic sulfonium salts comprising B(C₆F₅)₄⁻, PF₆⁻ or SbF₆⁻ as an anionic component are preferred, and onium salts such as aromatic sulfonium salts comprising B(C₆F₅)₄⁻ as an anionic component are more preferred from the viewpoint of curability and transparency of the cured product. The number of types of ultraviolet cationic polymerization initiators comprised in the curable resin composition may be one, or two or more.

The curable resin composition according to one aspect of the present invention may further comprise a thermal cationic polymerization initiator in the case of a thermosetting resin composition.

A thermal cationic polymerization initiator is a compound that generates acid by being subjected to a heat treatment and initiates a curing reaction of a cationically curable compound comprised in the curable resin composition A thermal cationic polymerization initiator is composed of a cationic moiety that absorbs heat and an anionic moiety that is a generation source of acid. The number of types of thermal cationic polymerization initiators may be one, or two or more.

Examples of the thermal cationic polymerization initiator include iodonium salt-based compounds and sulfonium salt-based compounds.

Examples of the cationic moiety of the thermal cationic polymerization initiator include monoarylsulfonium ions such as 4-hydroxyphenyl-methyl-benzylsulfonium ion, 4-hydroxyphenyl-methyl-(2-methylbenzyl)sulfonium ion, 4-hydroxyphenyl-methyl-1-naphthyl methyl sulfonium ion and p-methoxycarbonyloxyphenyl-benzyl-methylsulfonium ion.

Examples of the anionic moiety of the thermal cationic polymerization initiator include the same examples as the anionic moiety of the ultraviolet cationic polymerization initiator.

The curable resin composition according to one aspect of the present invention may further comprise additives such as coupling agents (such as silane-based coupling agents and titanium-based coupling agents), flexibility imparting agents (such as synthetic rubbers and polyorganosiloxanes), antioxidants, antifoaming agents, hydrocarbon-based waxes and inorganic fillers, as needed.

The total mass of resin components in the curable resin composition is the total content of diglycidyl ether compound A, bifunctional alicyclic epoxy compound B and polyfunctional epoxy compound C in the curable resin composition.

When the curable resin composition comprises an oxetane compound, the content of the oxetane compound is included in the total mass of the resin components.

When the curable resin composition comprises another resin, the content of the other resin is included in the total mass of the resin components.

When the curable resin composition comprises an ultraviolet cationic polymerization initiator, a thermal cationic polymerization initiator or an additive, the content of each of the ultraviolet cationic polymerization initiator, the thermal cationic polymerization initiator and the additive is not included in the total mass of the resin components.

The content of the diglycidyl ether compound A in the curable resin composition according to one aspect of the present invention is 30% by mass or more, preferably 30 to 50% by mass, more preferably 35 to 48% by mass, and still more preferably 40 to 45% by mass with respect to the total mass of the resin components.

When the content of the diglycidyl ether compound A is equal to or more than the lower limit value of the above numerical range, it is easy to obtain a cured product with excellent reliability at low temperatures. When the content of the diglycidyl ether compound A is equal to or less than the upper limit value of the above numerical range, a cured product having excellent heat resistance can be easily obtained.

The content of the bifunctional alicyclic epoxy compound B in the curable resin composition according to one aspect of the present invention is preferably 20 to 50% by mass, more preferably 30 to 45% by mass, and still more preferably 35 to 40% by mass with respect to the total mass of the resin components. When the content of the bifunctional alicyclic epoxy compound B is within the above range, it is easy to impart heat resistance and rigidity suitable for an optical element to the cured product.

The content of the polyfunctional epoxy compound C in the curable resin composition according to one aspect of the present invention is 20% by mass or less, preferably 10 to 20% by mass, and more preferably 15 to 20% by mass with respect to the total mass of the resin components.

When the content of the polyfunctional epoxy compound C is equal to or more than the lower limit value of the above numerical range, the crosslinking density of the entire cured product can be easily increased. When the content of the polyfunctional epoxy compound C is equal to or less than the upper limit value of the above numerical range, it is easy to obtain a cured product with excellent reliability at low temperatures.

The total content of the diglycidyl ether compound A and the bifunctional alicyclic epoxy compound B in the curable resin composition according to one aspect of the present invention is preferably 60 to 85% by mass, and more preferably 70 to 80% by mass with respect to the total mass of the resin components. When the total content is within the above range, it is easy to obtain a cured product that is excellent in both heat resistance at high temperatures and durability at low temperatures. Moreover, the breaking stress at low temperatures is further improved.

When the curable resin composition according to one aspect of the present invention comprises an oxetane compound, the content of the oxetane compound in the curable resin composition is preferably 3 to 20% by mass, more preferably 4 to 15% by mass, and still more preferably 5 to 10% by mass with respect to the total mass of the resin components.

When the content of the oxetane compound is equal to or more than the lower limit value of the above range, the curing rate of the curable resin composition by ultraviolet irradiation increases when the curable resin composition is ultraviolet curable. As a result, it becomes a suitable material for producing a wafer level lens by the UV imprint method. When the content of the oxetane compound is equal to or less than the upper limit value of the above range, the heat resistance of the cured product is less likely to decrease. As a result, the problem of causing wrinkles and cracks in the antireflection film required for optical elements is less likely to occur.

When the curable resin composition according to one aspect of the present invention comprises an ultraviolet cationic polymerization initiator, the content of the ultraviolet cationic polymerization initiator in the curable resin composition is preferably 0.05 to 10.0 parts by mass, and more preferably 0.1 to 3.0 parts by mass with respect to 100 parts by mass of the resin components in the curable resin composition. When the content of the ultraviolet cationic polymerization initiator is equal to or more than the lower limit value of the above range, the curability will be excellent. When the content of the ultraviolet cationic polymerization initiator is equal to or less than the upper limit value of the above range, coloring of the cured product can be easily suppressed.

When the curable resin composition according to one aspect of the present invention comprises another resin, the content of the other resin in the curable resin composition is preferably 1 to 20% by mass, more preferably 3 to 15% by mass, and still more preferably 5 to 10% by mass with respect to 100% by mass of the resin components in the curable resin composition.

When the content of the other resin is equal to or more than the lower limit value of the above numerical range, it is easy to impart the properties of the other resin to the cured product. When the content of the another resin is equal to or less than the upper limit value of the above numerical range, a cured product having excellent reliability at low temperatures can be easily obtained.

The use of the cured product obtained by curing the curable resin composition according to one aspect of the present invention is not particularly limited. Examples thereof include lenses and optical lenses.

The shape and outer diameter size of the cured product can be appropriately set in accordance with the application.

The thickness of the cured product is not particularly limited. For example, it can be 0.01 mm to 5.0 mm.

The breaking stress of the cured product at −10° C. is preferably 50 N/mm² or more, more preferably 60 N/mm² or more, and still more preferably 70 N/mm² or more. When the breaking stress is equal to or more than the lower limit value, the stress generated between the substrate and the cured product due to the difference in coefficient of linear expansion can be resisted, and cracks due to thermal shock are less likely to occur in the cured product. The higher the breaking stress, the better, and the upper limit of the breaking stress is, for example, about 80 N/mm².

The breaking elongation of the cured product at −10° C. is preferably 4.0% or more, more preferably 4.5% or more, and still more preferably 5.0% or more. When the breaking elongation is equal to or more than the lower limit value, the stress generated between the substrate and the cured product described above is alleviated, and cracks are less likely to occur in the cured product provided on the substrate. The greater the breaking elongation, the better, and the upper limit of the breaking elongation is, for example, about 10%.

The tensile modulus of the cured product at −10° C. is preferably 1,500 MPa or higher, more preferably 1,800 MPa or higher, and still more preferably 2,000 MPa or higher. When the tensile modulus is equal to or more than the lower limit value, the cured product will be sufficiently hard and will be excellent in resistance to physical impact and handleability. The higher the tensile modulus, the better, and the upper limit of the tensile modulus is, for example, about 3,000 MPa.

### Substrate-Attached Lens

A substrate-attached lens according to one aspect of the present invention comprises a substrate and a lens comprising a cured product of the curable resin composition according to one aspect of the present invention provided on the substrate. The substrate-attached lens according to one aspect of the present invention may be any one in which a lens formed of a cured product of the curable resin composition according to one aspect of the present invention is provided on a substrate. Therefore, in addition to a lens module in which one lens is provided on a substrate, a wafer level lens in which a plurality of lenses are provided on a substrate is also included in one aspect of the present invention.

The material that constitutes the substrate is not particularly limited. Examples thereof include glass, and resins such as acrylic resins, polycarbonate resins, epoxy resins, silicone resins, and polycycloolefin resins. Among them, a glass substrate is preferable from the viewpoint of rigidity and dimensional stability.

The shape and dimensions of the substrate are not particularly limited, and may be set as appropriate.

The shape and dimensions of the lens are not particularly limited, and may be set as appropriate.

The Abbe number of the lens is preferably 50 or more, more preferably 53 or more, and still more preferably 55 or more. When the Abbe number is equal to or higher than the lower limit value, chromatic aberration of the lens is less likely to occur, resulting in high resolution. The higher the Abbe number, the better, and the upper limit is not particularly limited, but is, for example, about 60.

The temperature coefficient (dn/dt) of the refractive index of the lens is preferably −150×10⁻⁶/K or more, more preferably −100×10⁻⁶/K or more, and still more preferably −80×10⁻⁶/K or more. When the temperature coefficient of the refractive index is equal to or higher than the lower limit value, the lens is less likely to be affected by changes in operating ambient temperature, and desired lens characteristics can be maintained. The closer the temperature coefficient of the refractive index is to 0, the better, and the upper limit is not particularly limited, but is, for example, about −50×10⁻⁶/K.

The method for producing the cured product is not particularly limited. Examples thereof include an imprint method using a mold, which uses the curable resin composition according to one aspect of the present invention. Specific examples thereof include a method of producing a cured product having a desired shape in which the ultraviolet-curable resin composition according to one aspect of the present invention is brought into contact with a mold having a concave portion having a shape corresponding to the shape of a desired cured product on the surface, and the ultraviolet-curable resin composition is cured by irradiating ultraviolet rays.

Examples of ultraviolet light sources include UV-LEDs, low pressure mercury lamps, high pressure mercury lamps, and ultra-high pressure mercury lamps.

The irradiation dose of ultraviolet rays is preferably 100 mJ/cm² to 30,000 mJ/cm², and more preferably 1,000 mJ/cm² to 20,000 mJ/cm².

Further, when the curable resin composition according to one aspect of the present invention is thermosetting, a cured product can be produced by using an imprint method using a mold in the same manner as described above. Examples thereof include a method of producing a cured product having a desired shape in which the thermosetting resin composition according to one aspect of the present invention is brought into contact with a mold having a concave portion having a shape corresponding to the shape of a desired cured product on the surface, and the thermosetting resin composition is cured by a heat treatment (for example, 80° C. to 250° C.).

Since a cured product formed from a conventional curable resin composition has a different coefficient of linear expansion from that of a glass substrate, stress is likely to occur due to temperature changes, and problems such as cracks and distortion are likely to occur, especially in low temperature environments.

On the other hand, as described above, the curable resin composition according to one aspect of the present invention comprises the diglycidyl ether compound A, the bifunctional alicyclic epoxy compound B and the polyfunctional epoxy compound C.

In addition, the content of the polyfunctional epoxy compound C is not too high and the content of the diglycidyl ether compound A is sufficient. Therefore, the durability of the cured product in a low temperature environment is improved, and even when the cured product is provided on a glass substrate, problems such as cracks and distortion are less likely to occur in a low temperature environment, and a cured product excellent in reliability can be obtained.

### Examples

The present invention will be specifically described below with reference to Examples, but the present invention is not limited by the following description. Cases 1 to 20 are Examples of the present invention. Cases 21 to 27 are Comparative Examples.

### [Raw Materials]

The raw materials used in these Examples are shown below.

### (Diglycidyl Ether Compound A)

A-1: jERYX-8000 (hydrogenated bisphenol A type epoxy resin, manufactured by Mitsubishi Chemical Corporation)

A-2: jERYX-8040 (hydrogenated bisphenol A type epoxy resin, manufactured by Mitsubishi Chemical Corporation)

### (Bifunctional Alicyclic Epoxy Compound B)

B-1: Celloxide 2021P (manufactured by Daicel Corporation)

B-2: THI-DE (manufactured by JXTG Nippon Oil & Energy Corporation)

B-3: HiREM-1 (manufactured by Shikoku Chemicals Corporation)

### (Polyfunctional Epoxy Compound C)

C-1: TEPIC-FL (manufactured by Nissan Chemical Industries, Ltd.)

C-2: TEPIC-UC (manufactured by Nissan Chemical Industries, Ltd.)

### (Oxetane Compound)

D-1: OXT-221 (manufactured by Toagosei Co., Ltd.)

### (Ultraviolet Cationic Polymerization Initiator)

E-1: Irgacure 290 (manufactured by BASF Japan Ltd.)

### (Other Resin)

F-1: Denacol EX-991L (manufactured by Nagase ChemteX Corporation)

### [Cases 1 to 27]

An ultraviolet-curable resin composition was prepared by mixing each component according to the composition shown in Tables 1 to 3.

### [Breaking Stress, Tensile Modulus, Breaking Elongation]

(1) Production of Test Sample

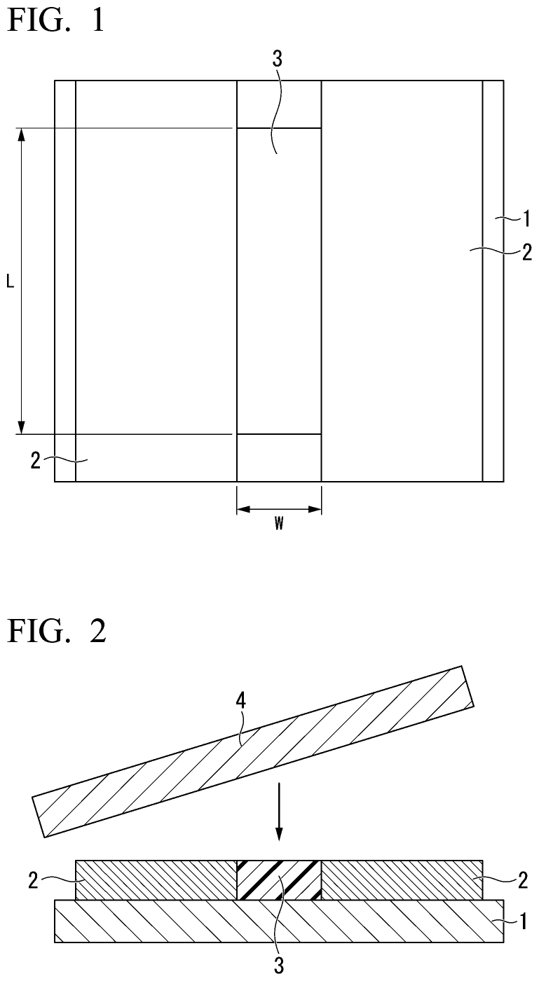

FIGS. 1 and 2 show the procedure for producing the test sample. One release-treated first glass substrate 1, two release-treated spacer glasses (thickness: 0.5 mm) 2, and one release-treated second glass substrate 4 were prepared. The two spacer glasses were placed in parallel on the first glass substrate 1 so that the distance (gap) W between the two spacer glasses 2 was 4 mm. The two spacer glasses 2 were arranged so that the thickness direction of the spacer glasses 2 was the normal direction with respect to the principal plane of the first glass substrate 1. After that, an ultraviolet-curable resin composition 3 was poured onto the principal plane of the first glass substrate 1 between (gap) the two spacer glasses 2 so as not to arise air bubbles. At this time, the ultraviolet-curable resin composition 3 was poured into a region having a width W of 4 mm on the principal plane of the first glass substrate 1 until a length L of the coated region reached 60 mm (FIG. 1).

Then, the second glass substrate 4 was superimposed so as to face the first glass substrate 1 and sandwich the two spacer glasses 2 and the ultraviolet-curable resin composition 3 therebetween with the first glass substrate 1 (FIG. 2). The sandwiched ultraviolet-curable resin composition 3 was irradiated with ultraviolet rays using an LED lamp with a wavelength of 365 nm at an exposure amount of 4,000 mJ/cm², and then cured by heating at 80° C. for 30 minutes using a hot plate. After that, a film-like cured product (4 mm (width)×60 mm (length)×0.5 mm (thickness)) was released from the first glass substrate 1, the two spacer glasses 2 and the second glass substrate 4, subjected to a heat treatment under the conditions of 180° C. for 3 hours in a nitrogen atmosphere, and used as a test sample.

(2) Tensile Test

Using an Autograph (manufactured by Shimadzu Corporation), a test sample was installed with an initial distance between jigs of 30 mm. The tension rate was set to 5 mm/min, and the breaking stress, breaking elongation and tensile modulus at −10° C. were measured. It should be noted that only the measuring portion of the Autograph was covered with a constant temperature bath, and the measurement was started after keeping the test sample for 30 minutes so that the temperature reached −10° C.

The tensile modulus was calculated from the slope between 0.05% and 0.25% of elongation percentage in accordance with JIS K7161.

### [Abbe Number, Temperature Coefficient of Refractive Index]

(1) Production of Test Sample

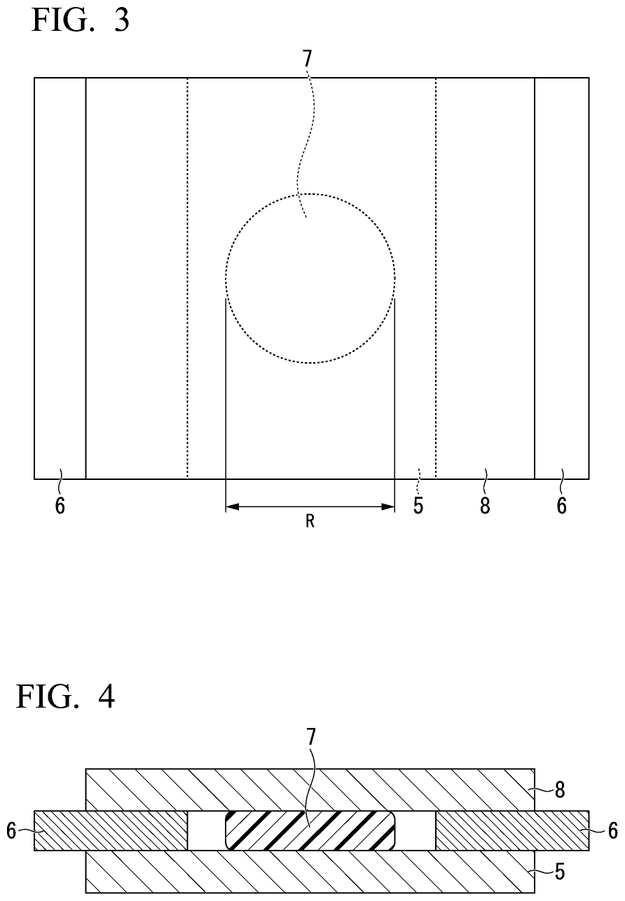

FIGS. 3 and 4 show the procedure for producing the test sample. One release-treated first glass substrate 5, two release-treated spacer glasses (thickness: 0.5 mm) 6, and one release-treated second glass substrate 8 were prepared. The two spacer glasses 6 were arranged in parallel on the first glass substrate 5 so that the distance between the two spacer glasses 6 was 30 mm or more. The two spacer glasses 6 were arranged so that the thickness direction of the spacer glasses 6 was the normal direction with respect to the principal plane of the first glass substrate 5. After that, about 0.3 g of an ultraviolet-curable resin composition was added dropwise onto the principal plane of the first glass substrate 5 between the two spacer glasses 6. At this time, the amount of the ultraviolet-curable resin composition added dropwise was adjusted so that when the second glass substrate 8 was placed so as to face the first glass substrate 5, a diameter R of an ultraviolet-curable composition 7 sandwiched therebetween in plan view exceeded 30 mm (FIGS. 3 and 4).

Then, the second glass substrate 8 was placed so as to face the first glass substrate 5, and the ultraviolet-curable resin composition was sandwiched therebetween. The sandwiched ultraviolet-curable resin composition 7 was irradiated with ultraviolet rays using an LED lamp with a wavelength of 365 nm at an exposure amount of 4,000 mJ/cm², and then cured by heating at 80° C. for 30 minutes using a hot plate. After that, a film-like cured product (about 30 mm (diameter)×0.5 mm (thickness)) was released from the first glass substrate 5, the two spacer glasses 6 and the second glass substrate 8, subjected to a heat treatment under the conditions of 180° C. for 3 hours in a nitrogen atmosphere, and used as a test sample.

(2) Calculation of Abbe Number

Using a prism coupler (Model 2010) manufactured by Metricon Corporation, lasers with wavelengths of 451 nm, 532 nm, 633 nm, and 932 nm were used to measure the refractive index of the test sample at each wavelength at 30° C. These measured values were substituted into Cauchy's dispersion formula to derive an approximation formula, and the Abbe number was calculated from the following formula (1).

v_{D}=(n_{D}−1)/(n_{F}−n_{c}) Formula 1

In the Formula 1, v_{D} is the Abbe number. n_{D} is the refractive index for light with a wavelength of 589 nm. n_{F} is the refractive index for light with a wavelength of 486 nm. nc is the refractive index for light with a wavelength of 656 nm.

(3) Calculation of Temperature Coefficient of Refractive Index

Using a prism coupler (Model 2010) manufactured by Metricon Corporation, lasers with wavelengths of 451 nm, 532 nm, 633 nm, and 932 nm were used to measure the refractive index of the test sample at each wavelength from 30° C. to 70° C. in 10° C. increments. For each temperature measurement, the test sample was held at the set temperature for 30 minutes before the measurement so that the temperature of the test sample reached the set temperature. The refractive index at each wavelength was plotted against temperature, the slope of the change in refractive index with respect to temperature was obtained for light of each wavelength, and the average value thereof was taken as the temperature coefficient of refractive index (dn/dt).

### [Reliability Test]

(1) Production of Evaluation Sample

A wafer level lens was produced by the following procedure.

A mold that has a circular shape in plan view, has a plurality of concave portions with a maximum depth of 0.5 mm and a diameter of 2.0 mm in plan view, and further has a shielding portion for blocking the transmission of ultraviolet rays between the concave portions was prepared. An ultraviolet-curable resin composition was placed in each concave portion of the mold, a 6-inch glass wafer was placed on the concave portion side of the mold, and the ultraviolet-curable resin composition was sandwiched by the mold and the glass wafer. After irradiating each ultraviolet-curable resin composition with ultraviolet rays at an exposure amount of 4,000 mJ/cm², the ultraviolet-curable resin composition in the concave portion was cured by heating at 80° C. for 30 minutes using a hot plate to form an optical lens. After the mold was separated, a heat treatment was further performed under the conditions of 180° C. for 3 hours in a nitrogen atmosphere to obtain a wafer level lens. In this wafer level lens, a cured product was provided on the glass wafer. Next, an antireflection film (AR film) was formed on the wafer level lens. The AR film was formed as a laminated film in which a total of six layers of SiO₂ layers and Al₂O₃ layers were alternately laminated. The film forming temperature of the AR film was set to 120° C. A wafer level lens with an AR film formed thereon was cut into individual pieces by blade dicing and used as an evaluation sample.

(2) Reliability Test

The evaluation sample was charged into a cold thermal shock tester (manufactured by ESPEC Corporation, model number: TSA-73ES). A temperature cycle was repeated, in which the temperature was: held for 30 minutes at −40° C.; and then raised to 85° C. at once and held for 30 minutes; and returned to −40° C. at once, and the lens of the evaluation sample after 1,000 cycles was observed with a stereoscopic microscope to confirm the presence or absence of cracks. Evaluation was performed in accordance with the following criteria.

### (Evaluation Criteria)

A: No cracks occurred in the lens.

B: A crack occurred in the lens.

The composition and test results of the ultraviolet-curable resin composition of each example are shown in Tables 1 to 3.

TABLE 1

| | | | Case 1 | Case 2 | Case 3 | Case 4 | Case 5 |
|---|---|---|---|---|---|---|---|
| Resin component | Diglycidyl ether compound A | A-1 | — | — | — | — | 40 |
| [parts by mass] | | A-2 | 50 | 40 | 30 | 30 | — |
| | Bifunctional alicyclic epoxy compound B | B-1 | 20 | 30 | 40 | 50 | 30 |
| | | B-2 | — | — | — | — | — |
| | | B-3 | — | — | — | — | — |
| | Polyfunctional epoxy compound C | C-1 | 20 | 20 | 20 | 10 | 20 |
| | | C-2 | — | — | — | — | — |
| | Oxetane compound | D-1 | 10 | 10 | 10 | 10 | 10 |
| | Other resin | F-1 | — | — | — | — | |
| | (A + B) Total content | | 70 | 70 | 70 | 80 | 70 |
| Ultraviolet cationic polymerization initiator | | E-1 | 0.5 | 0.5 | 0.5 | 0.3 | 0.5 |
| [parts by mass] | | | | | | | |
| Cured product | Tensile modulus [MPa] | | 1582 | 1965 | 2108 | 2167 | 1778 |
| | Breaking elongation (%) | | 5.8 | 5.0 | 5.5 | 2.9 | 5.3 |
| | Breaking stress [N/mm²] | | 53.3 | 68.3 | 74.9 | 52.7 | 64.7 |
| | Abbe number | | 52.1 | 51.9 | 51.8 | 51.4 | 52.5 |
| | Temperature coefficient of ochractive index (dn/dT) | | −149 | −148 | −145 | −143 | −120 |
| | Reliability test | | A | A | A | A | A |
| | | | Cose 6 | Case 7 | Case 8 | Case 9 | Case 10 |
| Resin component | Diglycidyl ether compound A | A-1 | 30 | — | — | — | — |
| [parts by mass] | | A-2 | — | 40 | 40 | 50 | 50 |
| | Bifunctional alicyclic epoxy compound B | B-1 | 40 | .— | — | — | — |
| | | B-2 | — | 30 | 30 | 30 | 30 |
| | | B-3 | — | — | — | — | — |
| | Polyfunctional epoxy compound C | C-1 | 20 | 20 | — | 10 | — |
| | | C-2 | — | — | 20 | — | 10 |
| | Oxetane compound | D-1 | 10 | 10 | 10 | 10 | 10 |
| | Other resin | F-1 | — | — | — | — | — |
| | (A + B) Total content | | 70 | 70 | 70 | 80 | 80 |
| Ultraviolet cationic polymerization initiator | | E-1 | 0.5 | 0.5 | 0.5 | 0.5 | 0.5 |
| [parts by mass] | | | | | | | |
| Cured product | Tensile modulus [MPa] | | 1977 | 1680 | 2139 | 1802 | 1927 |
| | Breaking elongation (%) | | 4.1 | 4.9 | 4.2 | 4.4 | 4.8 |
| | Breaking stress [N/mm²] | | 53.7 | 55.0 | 59.0 | 53.9 | 59.7 |
| | Abbe number | | 52.1 | 53.4 | 53.4 | 53.9 | 54.3 |
| | Temperature coefficient of ochractive index (dn/dT) | | −119 | −96 | −89 | −100 | −102 |
| | Reliability test | | Å | A | A | A | A |

TABLE 2

| | | | Case 11 | Case 12 | Case 13 | Case 14 | Case 15 |
|---|---|---|---|---|---|---|---|
| Resin component | Diglycidyl ether compound A | A-1 | — | — | — | — | — |
| [parts by mass] | | A-2 | 40 | 30 | 40 | 40 | 35 |
| | Bifunctional alicyclic epoxy compound B | B-1 | — | — | — | — | — |
| | | B-2 | 40 | 50 | 30 | 30 | 40 |
| | | B-3 | — | — | — | — | — |
| | Polyfunctional epoxy compound C | C-1 | 10 | 10 | — | — | — |
| | | C-2 | — | — | 5 | 10 | 10 |
| | Oxetane compound | D-1 | 10 | 10 | 10 | 10 | 10 |
| | Other resin | F-1 | — | — | 15 | 10 | 5 |
| | (A + B) Total content | | 80 | 80 | 70 | 70 | 75 |
| Ultraviolet cationic polymerization initiator | | E-1 | 0.5 | 0.5 | 0.5 | 0.5 | 0.5 |
| [parts by mass] | | | | | | | |
| Cured product | Tensile modulus [MPa] | | 1943 | 2065 | 1931 | 2138 | 2279 |
| | Breaking elongation [%] | | 3.6 | 3.3 | 5.7 | 6.1 | 4.1 |
| | Breaking stress [N/mm²] | | 54.3 | 54.9 | 68.6 | 70.6 | 66.5 |
| | Abbe mumber | | 53.9 | 54.2 | 54.1 | 54.3 | 54.5 |
| | Temperature coefficient of refractive index (dn/dT) | | −108 | −102 | −121 | −111 | −99 |
| | Rebability test | | A | A | A | A | A |
| | | | Case 16 | Case 17 | Case 18 | Case 19 | Case 20 |
| Resin component | Diglycidyl ether compound A | A-1 | — | — | — | — | — |
| [parts by mass] | | A-2 | 40 | 40 | 30 | 40 | 50 |
| | Bifunctional alicyclic epoxy compound B | B-1 | — | — | — | — | — |
| | | B-2 | 40 | 35 | 50 | — | — |
| | | B-3 | — | — | — | 30 | 30 |
| | Polyfunctional epoxy compound C | C-1 | — | 5 | 5 | 20 | 10 |
| | | C-2 | 10 | 10 | 10 | — | — |
| | Oxetane compound | D-1 | 5 | 5 | — | 10 | 10 |
| | Other resin | F-1 | 5 | 5 | 5 | — | — |
| | (A + B) Total content | | 80 | 75 | 80 | 70 | 80 |
| Ultraviolet cationic polymerization initiator | | E-1 | 0.5 | 0.5 | 0.5 | 0.5 | 0.5 |
| [parts by mass] | | | | | | | |
| Cured product | Tensile modulus [MPa] | | 2263 | 2319 | 2660 | 1911 | 1930 |
| | Breaking elongation [%] | | 4.8 | 4.3 | 4.5 | 4.3 | 5.4 |
| | Breaking stress [N/mm²] | | 71.5 | 56.8 | 79.2 | 32.9 | 58.9 |
| | Abbe mumber | | 53.3 | 54.8 | 54.8 | 543 | 54.6 |
| | Temperature coefficient of refractive index (dn/dT) | | −110 | −93 | −98 | −102 | −109 |
| | Rebability test | | A | A | A | A | A |

TABLE 3

| | | | Case 21 | Case 22 | Case 23 | Case 24 | Case 25 | Case 26 | Case 27 |
|---|---|---|---|---|---|---|---|---|---|
| Resin component | Diglycidyl ether compound. A | A-1 | — | — | — | — | 20 | — | — |
| [parts by mass] | | A-2 | 30 | 60 | 20 | 40 | — | 20 | 40 |
| | Bifunctional alicyclic epoxy compound B | B-1 | 20 | 30 | 50 | 50 | 50 | — | — |
| | | B-2 | — | — | — | — | — | 20 | 50 |
| | | B-3 | — | — | — | — | — | — | — |
| | Polyfunctional epoxy compound C | C-1 | 30 | — | 20 | — | 20 | 40 | — |
| | | C-2 | — | — | — | — | — | — | — |
| | Oxetane compound | D-1 | 20 | 10 | 10 | 10 | 10 | 20 | 10 |
| | Other resin | F-1 | — | — | — | — | — | — | — |
| | (A + B) Total content | | 50 | 90 | 70 | 90 | 70 | 40 | 90 |
| Ultraviolet cationic polymerization initiator | | E-1 | 0.5 | 0.5 | 0.5 | 0.5 | 0.5 | 0.5 | 0.5 |
| [parts by mass] | | | | | | | | | |
| Cured product | Tensile modules [MPa] | | 1336 | 1394 | 1942 | 2247 | 1858 | 1586 | 2083 |
| | Breaking elongation [%] | | 4.2 | 5.7 | 25 | 4.1 | 3.7 | 3.6 | 3.3 |
| | Breaking stress [N/mm²] | | 44.3 | 42.4 | 39.2 | 48.4 | 48.2 | 47.4 | 47.6 |
| | Abbe number | | 52.4 | 52.9 | 51.1 | 52.6 | 52.3 | 52.8 | 53.3 |
| | Temperature coefficient of refractive index (dn/dT) | | <−168 | <−172 | −102 | −94 | −98 | −146 | −92 |
| | Reliability test | | — | — | B | B | B | B | B |

As shown in Tables 1 and 2, the cured products of the ultraviolet-curable resin compositions of Cases 1 to 20 had a breaking stress of 50 N/mm² or more at −10° C., had high durability even at low temperatures, and were excellent in reliability at low temperatures. Further, in Cases 1 to 20, cracks did not occur in the lens even when the cured product provided on the glass wafer was repeatedly subjected to cooling/heating cycles of −40° C. and 85° C.

On the other hand, in Cases 21 to 27, the breaking stress at −10° C. was less than 50 N/mm^{2,} and the reliability at low temperatures was insufficient. Further, in Cases 23 to 27, cracks occurred in the lens when the cured product provided on the glass substrate was repeatedly subjected to cooling/heating cycles of −40° C. and 85° C. In Cases 21 and 22, the heat resistance of the cured product at high temperatures was insufficient. More specifically, in Cases 21 and 22, the heat resistance of the cured product was insufficient with respect to the film forming temperature of the AR film, wrinkles occurred on the surface of the AR film, and appropriate evaluation samples could not be obtained.

### INDUSTRIAL APPLICABILITY

According to the curable resin composition according to one aspect of the present invention, a cured product with excellent reliability at low temperatures can be obtained.

The cured product and lens according to one aspect of the present invention demonstrate excellent reliability at low temperatures.

A substrate-attached lens according to one aspect of the present invention comprises a lens with excellent reliability at low temperatures.

This application is a continuation application of International Application No. PCT/JP2021/044867, filed on Dec. 7, 2021, which claims the benefit of priority of the prior Japanese Patent Application No. 2020-206825 filed on Dec. 14, 2020, the entire contents of the specification, claims, drawings, and abstract of which are referenced and incorporated herein as the disclosure of the specification of the present invention.

### REFERENCE SIGNS LIST

1: First glass substrate

2: Spacer glass

3: Curable resin composition

4: Second glass substrate

5: First glass substrate

6: Spacer glass

7: Curable resin composition

8: Second glass substrate

1. A curable resin composition comprising:
a diglycidyl ether compound having a bisphenol skeleton;
a bifunctional alicyclic epoxy compound (excluding the diglycidyl ether compound); and
a trifunctional or higher polyfunctional epoxy compound having an isocyanurate ring structure,
wherein a content of the diglycidyl ether compound is 30% by mass or more with respect to a total mass of resin components in the curable resin composition; and
a content of the polyfunctional epoxy compound is 20% by mass or less with respect to the total mass of the resin components in the curable resin composition.

2. The curable resin composition according to claim 1,
wherein the content of the diglycidyl ether compound is from 30 to 50% by mass with respect to the total mass of the resin components in the curable resin composition.

3. The curable resin composition according to claim 1,
wherein a content of the bifunctional alicyclic epoxy compound is from 20 to 50% by mass with respect to the total mass of the resin components in the curable resin composition.

4. The curable resin according to claim 1,
wherein the content of the polyfunctional epoxy compound is from 10 to 20% by mass with respect to the total mass of the resin components in the curable resin composition.

5. The curable resin composition according to claim 1,
wherein a total content of the diglycidyl ether compound and the bifunctional alicyclic epoxy compound is from 60 to 85% by mass with respect to the total mass of the resin components in the curable resin composition.

6. The curable resin composition according to claim 1,
wherein the diglycidyl ether compound is either one or both of a bisphenol A type epoxy resin and a bisphenol F type epoxy resin.

7. The curable resin composition according to claim 1,
wherein the diglycidyl ether compound comprises a hydrogenated bisphenol skeleton.

8. The curable resin composition according to claim 1, further comprising an oxetane compound.

9. The curable resin composition according to claim 1, which is an ultraviolet-curable resin composition.

10. The curable resin composition according to claim 9, further comprising an ultraviolet cationic polymerization initiator.

11. The curable resin composition according to claim 1,
wherein a cured product of the curable resin composition has a breaking stress at −10° C. of 50 N/mm² or more.

12. The curable resin composition according to claim 1,
wherein a cured product of the curable resin composition has a tensile modulus at −10° C. of 1,500 MPa or more.

13. The curable resin composition according to claim 1,
wherein a cured product of the curable resin composition has a breaking elongation at −10° C. of 4% or more.

14. The curable resin composition according to claim 1,
wherein a cured product of the curable resin composition has an Abbe number of 50 or more.

15. A cured product of the curable resin composition according to claim 1.

16. A lens comprising the cured product according to claim 15.

17. The lens according to claim 16, which has a temperature coefficient of refractive index of −150×10⁻⁶/K or more.

18. A substrate-attached lens, comprising:
a substrate; and
the lens according to claim 16 provided on the substrate.
